(19) United States
(12) Patent Application Publication
(10) Pub. No.: US 2026/0232408 A1
(43) Pub. Date: Aug. 13, 2026

(54) FABRICATION MOLDS AND FABRICATION METHODS FOR ULTRA-HIGH PERFORMANCE CONCRETE-NORMAL CONCRETE (UHPC-NC) SPECIMENS

(71) Applicants: XI'AN UNIVERSITY OF ARCHITECTURE AND TECHNOLOGY, Xi'an (CN); SOUTH CHINA UNIVERSITY OF TECHNOLOGY, Guangzhou (CN)

(72) Inventors: Xiguang LIU, Xi'an (CN); Yichao ZHANG, Xi'an (CN); Bo WU, Guangzhou (CN); Rui REN, Xi'an (CN); Yao LYU, Xi'an (CN); Xinyu ZHAO, Guangzhou (CN); Jun LIU, Xi'an (CN); Li FAN, Xi'an (CN)

(73) Assignees: XI'AN UNIVERSITY OF ARCHITECTURE AND TECHNOLOGY, Xi'an (CN); SOUTH CHINA UNIVERSITY OF TECHNOLOGY, Guangzhou (CN)

(21) Appl. No.: 19/536,329

(22) Filed: Feb. 11, 2026

(30) Foreign Application Priority Data
Feb. 13, 2025 (CN) 202510157598.3

(51) Int. Cl. A61C 8/00; B29C 33/12; B29C 45/26

(52) U.S. Cl. CPC A61C 8/0056; A61C 8/005; B29C 33/12; B29C 45/2673

(57) ABSTRACT

Provided is a fabrication mold and a fabrication method for a UHPC-NC specimen. The fabrication mold includes a base, an assembled cylindrical barrel, a top cover, and an interface partition plate. A circular boss is disposed at a middle portion of the base. The assembled cylindrical barrel is arranged around a periphery of the circular boss. The interface partition plate is vertically inserted at a middle portion of the assembled cylindrical barrel. The top cover is buckled on a top portion of the assembled cylindrical barrel. A plurality of arc plates are spliced into the assembled cylindrical barrel through a detachable assembly. The detachable assembly includes a positioning plate, a limit shaft, and a regulator. An opening-closing state of the assembled cylindrical barrel is adjusted by rotating the regulator. The interface partition plate includes a base master plate, an adjustable sub plate, and a pushing element. Two ends of the base master plate abut against an inner wall of the assembled cylindrical barrel. The adjustable sub plate and the pushing element are cooperatively mounted on the base master plate. One side of the base master plate is configured to form a predetermined specimen interface morphology. One side of the adjustable sub plate is configured to form a variable specimen interface morphology.

### CROSS-REFERENCE TO RELATED APPLICATIONS

This application claims priority to the Chinese Patent Application No. 202510157598.3, filed on Feb. 13, 2025, the contents of which are hereby incorporated by reference.

### TECHNICAL FIELD

The present disclosure generally relates to a field of building material performance testing technology, and in particular to a fabrication mold and a fabrication method for an ultra-high performance concrete-normal concrete (UHPC-NC) specimen.

### BACKGROUND

In civil engineering, durability and safety of concrete structures are crucial. Ultra-high performance concrete (UHPC) has potential as a repair material due to excellent mechanical properties and durability of the UHPC. The UHPC is widely used in the field of repair and reinforcement of damaged engineering materials. A new ultra-high performance concrete-normal concrete (UHPC-NC) material is formed by combining the UHPC with normal concrete (NC), and the new UHPC-NC material repairs the original damaged material. However, after repair and reinforcement of a concrete structure, a bonding interface between the UHPC and the NC is often a weak region. The bonding interface is a key indicator for evaluating the bonding quality between new and old concrete.

In western regions, freeze-thaw cycles are one of the important factors affecting the bonding strength of an interface between new and old concrete. Concrete structures in cold regions are susceptible to freeze-thaw cycles, causing cracks inside concrete, degrading mechanical properties of concrete, and affecting a bonding effect of an interface between new and old concrete. However, an influence degree of freeze-thaw cycles on concrete performance is related to multiple factors such as low temperature and water content of concrete. Therefore, during construction in cold regions, the influence of freeze-thaw cycles on concrete performance and interface bonding strength should be fully considered, and corresponding measures should be taken to improve frost resistance and bonding strength of concrete.

Accordingly, it is necessary to conduct a dynamic mechanical property test of a UHPC-NC interface under freeze-thaw cycles actively, which can serve as a theoretical basis for later application in freeze-thaw cycle environments. However, existing research on bonding performance of the UHPC-NC interface is currently mainly focused on static mechanical properties, and there remains a lack of a method of the dynamic mechanical property test for the bonding performance of the UHPC-NC interface. Concrete structures in high-altitude cold regions are subjected to dynamic loads such as external impact (e.g., a heavy vehicle) or explosion of an oil tanker during service. After the concrete structure in long-term service is damaged due to external environmental conditions or dynamic loads, a damaged part of the concrete structure is usually repaired with high-performance materials. The repaired interface may still be subjected to the dynamic loads above during subsequent service. Current static mechanical property research method cannot evaluate dynamic splitting tensile strength of the repaired interface in the freeze-thaw environment, and no research has yet indicated which type of interface morphology has better mechanical repair effects.

Therefore, a fabrication mold and a fabrication method for a UHPC-NC specimen are provided. The fabrication mold can fabricate bonding interfaces of different morphologies between the UHPC and the NC, and dynamic splitting tensile strength of the UHPC-NC specimen is tested to solve the above problems.

### SUMMARY

In view of the deficiencies in the above existing technology, the present disclosure provides a fabrication mold and a fabrication method for an ultra-high performance concrete-normal concrete (UHPC-NC specimen). Based on Brazilian disk splitting test requirements, the fabrication mold of the present disclosure is used to fabricate UHPC-NC specimens with circular cross-sections and different interface morphologies. After the UHPC-NC specimens are eroded in a predetermined freeze-thaw cycle environment, dynamic splitting tensile strength tests are performed on the UHPC-NC specimens to solve the problems in the background technology.

One or more embodiments of the present disclosure provide a fabrication mold for a UHPC-NC specimen, including a base, an assembled cylindrical barrel, a top cover, and an interface partition plate, wherein a middle portion of the base is provided with a circular boss, the assembled cylindrical barrel is arranged at an outer periphery of the circular boss, the interface partition plate is vertically inserted into a middle portion of the assembled cylindrical barrel, and the top cover is buckled on a top portion of the assembled cylindrical barrel; the assembled cylindrical barrel is formed by splicing a plurality of arc plates, an outer wall of each of the plurality of arc plates is provided with a detachable assembly, the detachable assembly includes a positioning plate, a limit shaft, and a regulator, the positioning plate is fixedly connected to the base, the limit shaft and the regulator are respectively connected to each of the plurality of arc plates and penetrate through the positioning plate, and an opening-closing state of the assembled cylindrical barrel is adjusted by rotating the regulator; and the interface partition plate includes a base master plate, an adjustable sub plate, and a pushing element, the base master plate is connected to the circular boss, and two ends of the base master plate abut against an inner wall of the assembled cylindrical barrel, the adjustable sub plate and the pushing element are cooperatively mounted on the base master plate, one side of the base master plate is configured to form a predetermined specimen interface morphology, and one side of the adjustable sub plate is configured to form a variable specimen interface morphology.

One or more embodiments of the present disclosure provide a fabrication method for a UHPC-NC specimen by using the fabrication mold for the UHPC-NC specimen, and the fabrication method including: combining the plurality of arc plates to form the assembled cylindrical barrel, and installing the interface partition plate in the assembled cylindrical barrel; adding normal concrete (NC) to one side of the interface partition plate according to a requirement of a designed interface morphology of the UHPC-NC specimen, after curing is completed, removing the interface partition plate, then adding ultra-high performance concrete (UHPC) to fill the assembled cylindrical barrel, and continuing curing; in response to fabricating a UHPC-NC specimen with a sawtooth-shaped interface, using the interface adjustment member to push the pushing element to deform the elastic arc panel from the arc shape into the sawtooth shape, then adding the NC to one side of the elastic arc panel, after curing is completed, removing the interface partition plate, then adding the UHPC to fill the assembled cylindrical barrel, and continuing curing, and after curing is completed, rotating a plurality of rotating handles to drive the plurality of arc plates to move away from each other by using threaded rods, thereby opening the assembled cylindrical barrel, and taking out the UHPC-NC specimen.

### BRIEF DESCRIPTION OF THE DRAWINGS

The present disclosure is further described in an exemplary manner by way of embodiments, which are described in detail with reference to the drawings. These embodiments are not limiting. In these embodiments, the same reference numerals denote the same structures, wherein:

FIG. 1 is a schematic diagram of an overall structure of a fabrication mold for an ultra-high performance concrete-normal concrete (UHPC-NC) specimen according to some embodiments of the present disclosure;

FIG. 2 is a schematic diagram of a structure of a detachable assembly according to some embodiments of the present disclosure;

FIG. 3 is a schematic diagram of a cooperation relationship between a detachable assembly and an arc plate according to some embodiments of the present disclosure;

FIG. 4 is a schematic diagram of a positional relationship between an assembled cylindrical barrel and an interface partition plate according to some embodiments of the present disclosure;

FIG. 5 is a schematic diagram of a structure of the interface partition plate according to some embodiments of the present disclosure;

FIG. 6 is a schematic diagram of a structure of a base master plate according to some embodiments of the present disclosure;

FIG. 7 is a schematic diagram of a cooperation relationship between a pushing element and an elastic arc panel according to some embodiments of the present disclosure;

FIG. 8 is a schematic diagram of an original state of an elastic arc panel according to some embodiments of the present disclosure;

FIG. 9 is a schematic diagram of a structure of a pushing element according to some embodiments of the present disclosure;

FIG. 10 is a schematic diagram of an elastic arc panel changing from an arc shape to a sawtooth shape according to some embodiments of the present disclosure;

FIG. 11 is a schematic diagram of a cooperation relationship between an interface adjustment member and an interface partition plate according to some embodiments of the present disclosure;

FIG. 12 is a flowchart illustrating an exemplary process of a fabrication method for a UHPC-NC specimen according to some embodiments of the present disclosure;

FIG. 13 is a schematic diagram of a temperature rise and fall mechanism and a duration of high temperature and low temperature according to some embodiments of the present disclosure;

FIG. 14 is a schematic diagram of clamping of a UHPC-NC specimen on a split Hopkinson pressure bar (SHPB) test bench according to some embodiments of the present disclosure;

FIG. 15 is a schematic diagram of a partial enlarged structure of a UHPC-NC specimen during loading according to some embodiments of the present disclosure;

FIG. 16 is a point-line diagram of dynamic splitting tensile strength of UHPC-NC specimens with three interface morphologies under different counts of freeze-thaw cycles and an impact air pressure of 0.1 MPa according to some embodiments of the present disclosure;

FIG. 17 is a point-line diagram of dynamic splitting tensile strength of UHPC-NC specimens with three interface morphologies under different counts of freeze-thaw cycles and an impact air pressure of 0.125 MPa according to some embodiments of the present disclosure;

FIG. 18 is a point-line diagram of dynamic splitting tensile strength of UHPC-NC specimens with three interface morphologies under different counts of freeze-thaw cycles and an impact air pressure of 0.15 MPa according to some embodiments of the present disclosure.

In the drawings: 1, base; 11, circular boss; 111, clamping groove; 2, assembled cylindrical barrel; 21, arc plate; 211, first mounting disc; 212, second mounting disc; 3, top cover; 4, interface partition plate; 41, base master plate; 411, rectangular protrusion; 412, limiting post; 413, gap; 401, linear actuator; 42, adjustable sub plate; 421, T-shaped post; 422, elastic arc panel; 43, pushing element; 431, flat plate; 432, pushing plate; 5, detachable assembly; 51, positioning plate; 52, limit shaft; 53, regulator; 531, rotating handle; 532, threaded rod; 533, connecting disc; 6, interface adjustment member; 61, cover plate; 62, insertion rod; 621, cone; 622, first cylinder; 623, second cylinder; 7, elastic rubber column; 8, incident bar; 9, transmitted bar; 10, rigid pad strip; 20, strain gauge.

### DETAILED DESCRIPTION

To illustrate the technical solutions in the embodiments of the present disclosure more clearly, the following briefly introduces the accompanying drawings required for describing the embodiments. Obviously, the accompanying drawings in the following description show only some examples or embodiments of the present disclosure. For a person of ordinary skill in the art, the present disclosure may be applied to other similar scenarios according to these accompanying drawings without creative efforts. Unless obviously obtained from the context or the context illustrates otherwise, the same numeral in the drawings refers to the same structure or operation.

It should be understood that the terms “system”, “device”, “unit”, and/or “module” used herein are a method for distinguishing different components, elements, parts, sections, or assemblies at different levels. However, if other words can achieve the same purpose, the words may be replaced by other expressions.

As shown in the present disclosure, unless the context clearly indicates an exception, the words “a”, “an”, “one”, and/or “the” are not limited to the singular form and may also include the plural form. Generally, the terms “include” and “comprise” only indicate that explicitly identified steps and elements are included. The steps and elements do not constitute an exclusive list. A method or device may also include other steps or elements.

The present disclosure uses flowcharts to illustrate operations performed by a system according to embodiments of the present disclosure. It should be understood that the preceding or following operations are not necessarily performed precisely in sequence. On the contrary, the steps may be processed in reverse order or simultaneously. Meanwhile, other operations may be added to the processes, or one or more operations may be removed from the processes.

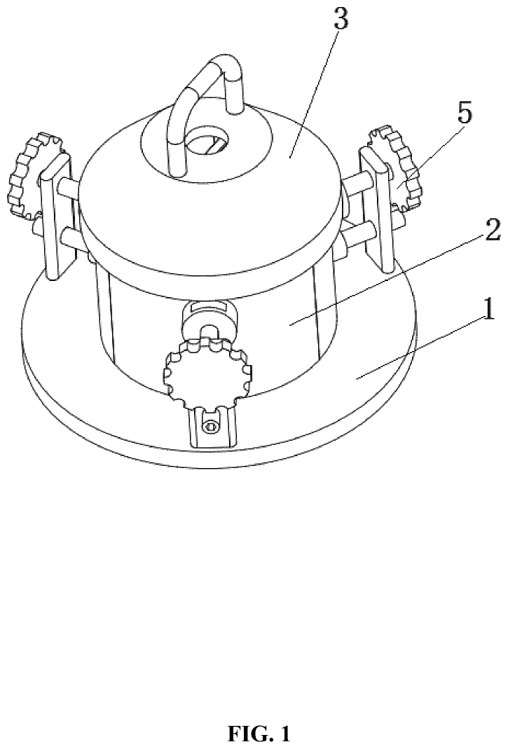

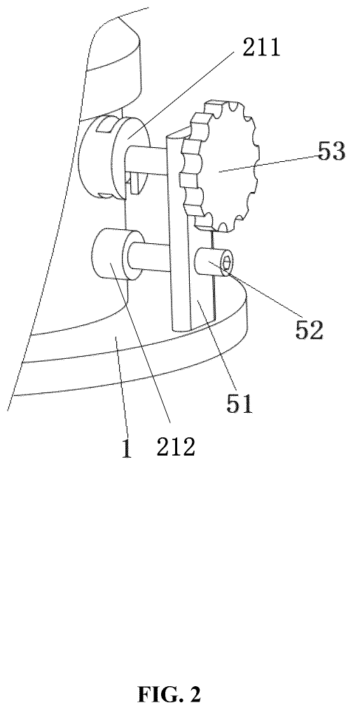

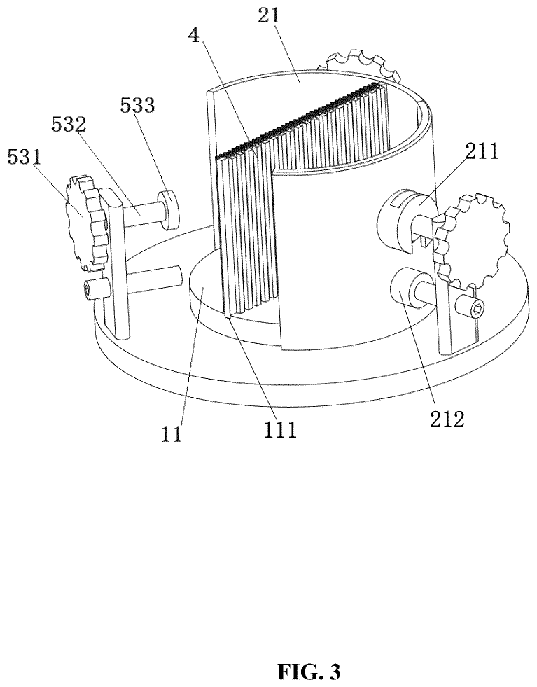

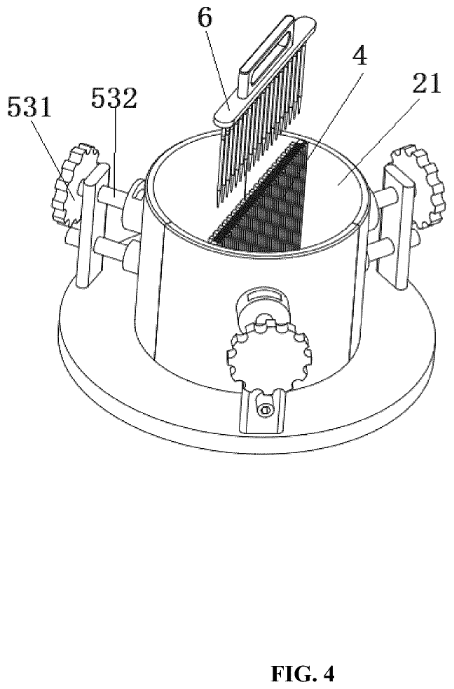

FIG. 1 is a schematic diagram of an overall structure of a fabrication mold for an ultra-high performance concrete-normal concrete (UHPC-NC) specimen according to some embodiments of the present disclosure. FIG. 2 is a schematic diagram of a structure of a detachable assembly according to some embodiments of the present disclosure. FIG. 3 is a schematic diagram of a cooperation relationship between a detachable assembly and an arc plate according to some embodiments of the present disclosure. FIG. 4 is a schematic diagram of a positional relationship between an assembled cylindrical barrel and an interface partition plate according to some embodiments of the present disclosure.

In some embodiments, with reference to FIG. 1 to FIG. 4, some embodiments of the present disclosure provide a fabrication mold for a UHPC-NC specimen (hereinafter referred to as the fabrication mold). The fabrication mold includes a base 1, an assembled cylindrical barrel 2, a top cover 3, and an interface partition plate 4. A middle portion of the base 1 is provided with a circular boss 11, the assembled cylindrical barrel 2 is arranged at an outer periphery of the circular boss 11, the interface partition plate 4 is vertically inserted into a middle portion of the assembled cylindrical barrel 2, and the top cover 3 is buckled on a top portion of the assembled cylindrical barrel 2.

The base 1 is configured to support an overall structure of the fabrication mold and provide bottom support for a specimen. The base 1 may be made of steel, cast iron, or the like.

The assembled cylindrical barrel 2 is configured to form the UHPC-NC specimen.

The top cover 3 is configured to seal the assembled cylindrical barrel 2. An outer diameter of the top cover 3 matches an inner diameter of the top portion of the assembled cylindrical barrel 2.

In some embodiments, the top cover 3 and the top portion of the assembled cylindrical barrel 2 may be buckled in various manners. For example, an edge of the top cover 3 may be designed with a groove or a flange matching the top portion of the assembled cylindrical barrel 2, and the top cover 3 and the top portion of the assembled cylindrical barrel 2 may be buckled by gravity or slight pressure. As another example, the top cover 3 and the assembled cylindrical barrel 2 may be buckled by an external locking mechanism (e.g., a bolt, a quick-release buckle, or a pressing device) so that the top cover 3 does not become loose during specimen fabrication and provides necessary compaction effect. The top cover 3 may also be buckled in other suitable manners.

In some embodiments, the top cover 3 has a conical structure, and an exhaust hole is opened at a top portion of the top cover 3. During specimen fabrication, the fabrication mold needs to be placed on a vibrating table for vibration, the top cover 3 can prevent material in the assembled cylindrical barrel 2 from overflowing outward due to vibration.

In some embodiments, the base 1, the assembled cylindrical barrel 2, and the top cover 3 enclose a mold cavity, and a UHPC-NC specimen is formed by pouring material (e.g., ultra-high performance concrete (UHPC), normal concrete (NC)) into the mold cavity.

The interface partition plate 4 is configured to separate different materials (e.g., UHPC and NC) and form an interface morphology between the different materials.

In some embodiments, a size of the interface partition plate 4 matches an inner diameter of the assembled cylindrical barrel 2. The interface partition plate 4 divides the mold cavity inside the assembled cylindrical barrel 2 into two semi-cylindrical regions.

In some embodiments, two side surfaces of the interface partition plate 4 may be used to form different interface morphologies. Contact surfaces between the interface partition plate 4 and the assembled cylindrical barrel 2 are arc surfaces, and when the interface partition plate 4 is installed inside the assembled cylindrical barrel 2, the interface partition plate 4 can completely fit the assembled cylindrical barrel 2. After NC is poured on one side of the interface partition plate 4, the interface partition plate 4 may be extracted from the assembled cylindrical barrel 2. Then the UHPC is added to fill the assembled cylindrical barrel 2 to obtain the UHPC-NC specimen.

The circular boss 11 is configured for positioning the assembled cylindrical barrel 2 and the interface partition plate 4.

In some embodiments, as shown in FIG. 3, a clamping groove 111 is provided in a middle portion of the circular boss 11. The interface partition plate 4 is vertically inserted into the middle portion of the assembled cylindrical barrel 2 and cooperates with the clamping groove 111.

In some embodiments, the circular boss 11 is disposed in the middle portion of the base 1 by integral molding or fixed connection.

In some embodiments, an inner wall of the assembled cylindrical barrel 2 fits with an outer wall of the circular boss 11. For example, an outer diameter of the circular boss 11 and an inner diameter of the assembled cylindrical barrel 2 may be designed with a fit tolerance, so that the assembled cylindrical barrel 2 can be precisely positioned around the circular boss 11. As another example, during installation, the assembled cylindrical barrel 2 may be fixed around the outer periphery of the circular boss 11 by an external fastener (e.g., a clamp or a bolt) to prevent displacement during material pouring.

In some embodiments, as shown in FIG. 2 to FIG. 4, the assembled cylindrical barrel 2 is formed by splicing a plurality of arc plates 21. An outer wall of each of the plurality of arc plates 21 is provided with a detachable assembly 5. The detachable assembly 5 includes a positioning plate 51, a limit shaft 52, and a regulator 53. The positioning plate 51 is fixedly connected to the base 1. The limit shaft 52 and the regulator 53 are respectively connected to each of the plurality of arc plates 21 and penetrate through the positioning plate 51. An opening-closing state of the assembled cylindrical barrel 2 is adjusted by rotating the regulator 53.

The arc plates 21 are configured to constitute a cylindrical structure of the assembled cylindrical barrel 2. In some embodiments, the plurality of arc plates 21 may be spliced by bolt connection or buckle connection to form the cylindrical barrel structure. For example, side edges of the arc plates 21 may be provided with matching connection structures, and the assembled cylindrical barrel 2 is formed by snap-fitting or bolt-fixing the connection structures. Those in the art may select a suitable splicing manner according to a specific application scenario.

In some embodiments, each of the plurality of arc plates 21 is connected to the base 1 through the detachable assembly 5.

The detachable assembly 5 is configured to implement functions such as installation, disassembly, adjustment, or positioning of the arc plate 21.

In some embodiments, the detachable assembly 5 may be disposed on the outer wall of the arc plate 21 and be fixedly installed on the base 1 by a bolt, a rivet, or the like. As another example, the detachable assembly 5 may be designed to be installed on the outer wall of the arc plate 21 through a clamping groove or a quick-locking mechanism to facilitate maintenance and replacement.

The positioning plate 51 is configured to limit or determine a position of the detachable assembly 5.

In some embodiments, the positioning plate 51 may be connected to the base by bolts, welding, or the like.

The limit shaft 52 is configured to limit a position and a movement range of the arc plate 21.

In some embodiments, the limit shaft 52 may be fixedly connected to the arc plate 21 by threaded connection or riveting. The limit shaft may be designed as a smooth rod, and an end of the limit shaft passes through a preset hole in the positioning plate 51.

Merely by way of example, as shown in FIG. 3 to FIG. 4, the limit shaft 52 is threadedly connected to a second mounting disc 212 on the outer wall of the arc plate 21.

The regulator 53 is configured to adjust an opening-closing state of the arc plate 21. The opening-closing state includes an open state and a closed state. In the open state, the plurality of arc plates 21 are separated from each other. In the closed state, the plurality of arc plates 21 are close to each other and spliced together.

In some embodiments, the regulator 53 is fixedly connected to the arc plate 21 by threaded connection or riveting.

In some embodiments, the regulator 53 is located above the limit shaft 52.

In some embodiments, a plurality of the detachable assemblies are provided, and each of the detachable assemblies includes a positioning plate 51, a limit shaft 52, and a regulator 53. Each arc plate 21 is correspondingly provided with a positioning plate 51, a limit shaft 52, and a regulator 53.

For example, as shown in FIG. 1 to FIG. 2, the assembled cylindrical barrel 2 is formed by splicing three arc plates 21. Three positioning plates 51 are provided and are uniformly arranged circumferentially at an edge of the base 1, and three limit shafts 52 pass through and are connected to the three positioning plates 51 and are threadedly connected to three second mounting discs 212 on the outer walls of the three arc plates 21.

By rotating knobs of the regulators 53, the regulators 53 may be screwed into or out of a threaded hole, thereby achieving mutual switching between the open state and the closed state of the plurality of arc plates 21.

In some embodiments, by screwing the knobs of the regulators 53, the plurality of arc plates 21 are pushed to move in a direction away from the positioning plates 51, and the limit shafts 52 synchronously move, and the plurality of arc plates 21 switch from the open state to the closed state, thereby forming the assembled cylindrical barrel 2. In some embodiments, after pouring is completed, by screwing the knobs of the regulators 53, the plurality of arc plates 21 are pulled to move in a direction toward the positioning plates 51, the limit shafts 52 synchronously move, and the plurality of arc plates 21 switch from the closed state to the open state, thereby completing demolding.

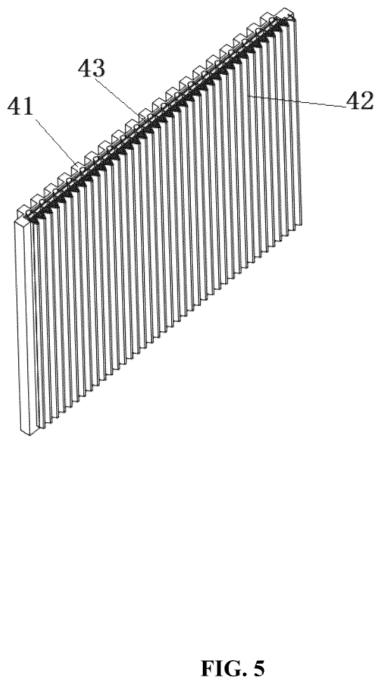

FIG. 5 is a schematic diagram of a structure of the interface partition plate according to some embodiments of the present disclosure.

In some embodiments, as shown in FIG. 4 to FIG. 5, the interface partition plate 4 includes a base master plate 41, an adjustable sub plate 42, and a pushing element 43. The base master plate 41 is connected to the circular boss 11, and two ends of the base master plate 41 abut against an inner wall of the assembled cylindrical barrel 2. The adjustable sub plate 42 and the pushing element 43 are cooperatively mounted on the base master plate 41. One side of the base master plate 41 is configured to form a predetermined specimen interface morphology, and one side of the adjustable sub plate 42 is configured to form a variable specimen interface morphology.

The base master plate 41 is configured to support, fix, and provide the predetermined specimen interface morphology. A side of the base master plate 41 away from the adjustable sub plate 42 is configured to form the predetermined specimen interface morphology. A morphology of the base master plate 41 may be preset according to requirements to form the predetermined specimen interface morphology. For example, as shown in FIG. 5, the side of the base master plate 41 away from the adjustable sub plate 42 is a plurality of continuous rectangles. The base master plate 41 may be made of materials with relatively high strength such as stainless steel, aluminum alloy, etc. to ensure shape stability.

In some embodiments, the two ends of the base master plate 41 abut against the inner wall of the assembled cylindrical barrel 2 in a plurality of ways. For example, a width of the base master plate 41 may be slightly smaller than an inner diameter of the assembled cylindrical barrel 2, elastic sealing members may be provided at the two ends of the base master plate 41, and the elastic sealing members are compressed to be in close contact with the inner wall of the cylindrical barrel. As another example, the two ends of the base master plate 41 may be designed to have a shape matching a curvature of the inner wall of the assembled cylindrical barrel 2. The base master plate 41 is inserted into the assembled cylindrical barrel 2 by interference fit, i.e., a distance between the two ends of the base master plate 41 is slightly larger than the inner diameter of the assembled cylindrical barrel 2, to ensure axial stability and radial support. In some embodiments, the two ends of the base master plate 41 may abut against the inner wall of the assembled cylindrical barrel 2 in other feasible ways.

The adjustable sub plate 42 is configured to change a specimen interface morphology by adjusting a surface morphology. The adjustable sub plate 42 includes materials with deformation capability, such as shape memory alloy, flexible polymer material, or the like, to achieve deformation.

The pushing element 43 is configured to drive the adjustable sub plate to deform, thereby achieving adjustment of the specimen interface morphology.

In some embodiments, the adjustable sub plate 42 and the pushing element 43 may be cooperatively mounted on the base master plate 41 in a plurality of ways. For example, a guide groove or a mounting hole may be provided on the base master plate 41, and the adjustable sub plate 42 may slide in the guide groove or the mounting hole.

In some embodiments of the present disclosure, the fabrication mold for the UHPC-NC specimen is overall formed by splicing the plurality of arc plates distributed circumferentially. The detachable assemblies adjust positions of the arc plates to open the assembled cylindrical barrel formed by the three arc plates, thereby facilitating rapid demolding after the UHPC-NC specimen is fabricated, avoiding significant disturbance to the UHPC-NC specimen caused by mold disassembly in existing molds, and ensuring accuracy of subsequent test results for splitting tensile strength of a bonding interface of the UHPC-NC specimen. By providing the interface partition plate, the interface partition plate includes a side with a predetermined morphology and a side with a variable morphology. The side with the predetermined morphology of the interface partition plate is used to fabricate a specimen with a rectangular interface morphology. The side with the variable morphology of the interface partition plate can realize fabrication of a specimen with an arc interface morphology in an undeformed state, so that flexible adjustment can be performed according to different requirements for interface morphology, thereby improving applicability of the fabrication mold.

It should be noted that the above description of the fabrication mold for the UHPC-NC specimen is merely for example and illustration and does not limit the applicable scope of the present disclosure. For those skilled in the art, various modifications and changes may be made to the fabrication mold for the UHPC-NC specimen under the guidance of the present disclosure. However, these modifications and changes are still within the scope of the present disclosure.

In some embodiments, as shown in FIG. 3 to FIG. 4, the regulator 53 includes a rotating handle 531, a threaded rod 532, and a connecting disc 533. The threaded rod 532 movably passes through the positioning plate 51. The rotating handle 531 and the connecting disc 533 are respectively connected to two ends of the threaded rod 532, and the connecting disc 533 is located inside a first mounting disc 211 on the outer wall of an arc plate 21.

The rotating handle 531 is configured to rotate the regulator 53.

The threaded rod 532 is configured to convert rotary motion into linear motion.

In some embodiments, the threaded rod 532 is in threaded engagement with the positioning plate 51. The positioning plate 51 is provided with a threaded through hole, and the threaded rod 532 passes through the threaded through hole in the positioning plate 51. An external thread of the threaded rod 532 matches an internal thread of the threaded through hole.

The connecting disc 533 is configured to achieve connection between the threaded rod 532 and the arc plate 21 and to provide support for the threaded rod 532.

In some embodiments, the rotating handle 531 may be fixed to one end of the threaded rod 532 by threads, pins, welding, or the like. When a user rotates the rotating handle 531, the threaded rod 532 rotates synchronously. In some embodiments, the connecting disc 533 may be fixed to the other end of the threaded rod 532 by threads, pins, welding, press fit, or the like.

The first mounting disc 211 is configured to accommodate the connecting disc 533. In some embodiments, the first mounting disc 211 has a cavity or a recess inside, and the connecting disc 533 is placed inside the cavity or the recess. The connecting disc 533 may rotate relative to the first mounting disc 211.

In some embodiments, when the user rotates the rotating handle 531, the rotating handle 531 drives the threaded rod 532 to rotate, thereby causing the connecting disc 533 to rotate inside the first mounting disc 211. Through cooperation between the threaded rod 532 and the positioning plate 51, the plurality of arc plates 21 move toward each other to be spliced together to form the assembled cylindrical barrel 2, or the plurality of arc plates 21 move away from each other to open the assembled cylindrical barrel 2 to demold the fabricated specimen.

Some embodiments of the present disclosure provide a regulator with a clear structure and convenient operation. The regulator achieves precise positional adjustment of components in the fabrication mold through a combination of the rotating handle, the threaded rod, and the connecting disc. Cooperation between the threaded rod and the positioning plate and positioning of the connecting disc inside the first mounting disc ensure stability and reliability of an adjustment process, thereby effectively avoiding problems of component misalignment or inaccurate adjustment, and improving machining accuracy and production efficiency of the fabrication mold.

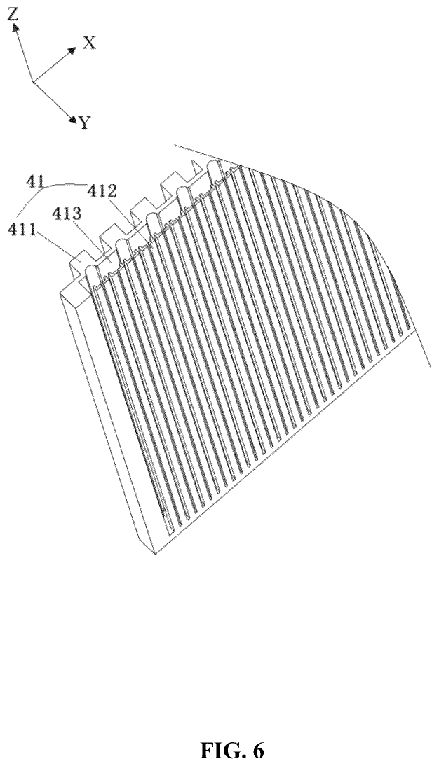

FIG. 6 is a schematic diagram of a structure of a base master plate according to some embodiments of the present disclosure.

In some embodiments, as shown in FIG. 6, one side of the base master plate 41 is provided with a plurality of rectangular protrusions 411, and another side of the base master plate 41 is uniformly provided with a plurality of limiting posts 412. A gap 413 is formed between the plurality of rectangular protrusions 411 and the plurality of limiting posts 412. Each of the plurality of limiting posts 412 includes two L-shaped baffles symmetrical to each other, and a spacing is provided between the two L-shaped baffles.

The rectangular protrusions 411 are structures protruding from a surface of the base master plate 41 and having rectangular cross-sections. The rectangular protrusions 411 are configured to form a specimen interface morphology with a continuous rectangle (the predetermined specimen interface morphology). Sizes of the rectangular protrusions 411 may be set based on experience or requirements.

In some embodiments, the plurality of rectangular protrusions 411 are integrally formed with the base master plate 41, for example, by casting, injection molding, or computer numerical control (CNC) machining, to ensure structural strength and positioning accuracy of the plurality of rectangular protrusions 411.

The limiting post 412 is configured to limit a range of motion of the pushing element 43.

In some embodiments, for each of the plurality of limiting posts 412, the limiting post 412 is fixedly connected to an end of the base master plate 41 proximate to the circular boss 11. For example, position points may be marked in advance on the end of the base master plate 41 proximate to the circular boss 11, followed by precise drilling and installation of the limiting post 412. As another example, the limiting post 412 may be integrally formed with the base master plate 41.

In some embodiments, the plurality of limiting posts 412 are uniformly spaced along a length direction of the base master plate 41 (e.g., an X-axis direction in FIG. 6).

The gap 413 is configured to accommodate the pushing element 43. The pushing element 43 is located in the gap 413. The pushing element 43 may move in the gap 413 along a direction toward the limiting post 412 (e.g., a positive direction of the Y-axis).

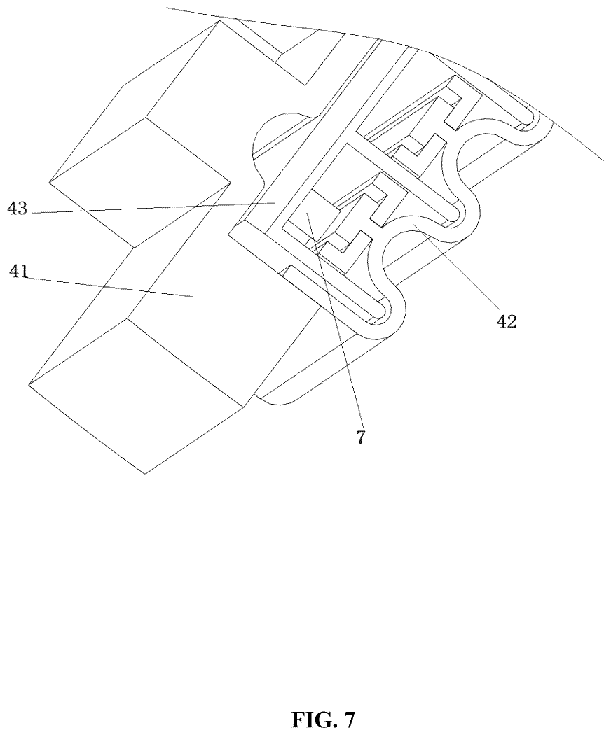

FIG. 7 is a schematic diagram of a cooperation relationship between a pushing element and an elastic arc panel according to some embodiments of the present disclosure. In some embodiments, as shown in FIG. 7, a plurality of elastic rubber columns 7 are connected to the adjustable sub plate 42, and the pushing element 43 contacts the plurality of elastic rubber columns 7. The adjustable sub plate 42 is connected to the base master plate 41 through the plurality of limiting posts 412. The pushing element 43 is installed in the gap 413 and extends to cooperate with the adjustable sub plate 42, and the pushing element 43 and the adjustable sub plate 42 are connected through the plurality of elastic rubber columns 7.

The L-shaped baffles are configured to block the pushing element 43 to limit a range of motion of the pushing element 43 and has an L-shaped cross-section. The L-shaped baffles may also fix a position of one end of the adjustable sub plate 42. For example, an end of the adjustable sub plate 42 proximate to the base master plate 41 is engaged in the spacing between the L-shaped baffles.

In some embodiments of the present disclosure, the plurality of rectangular protrusions are arranged on one side of the base master plate, the plurality of limiting posts are uniformly arranged on another side of the base master plate, and the gap formed between the plurality of rectangular protrusions and the plurality of limiting posts, thereby achieving precise bidirectional positioning and effective limiting of the fabricated specimen. Each of the plurality of limiting post adopts two symmetrical L-shaped baffles with a spacing, further improving clamping stability and positioning accuracy for the specimen, thereby avoiding shaking or displacement of the workpiece during a fabrication process to significantly improve fabrication efficiency and product quality.

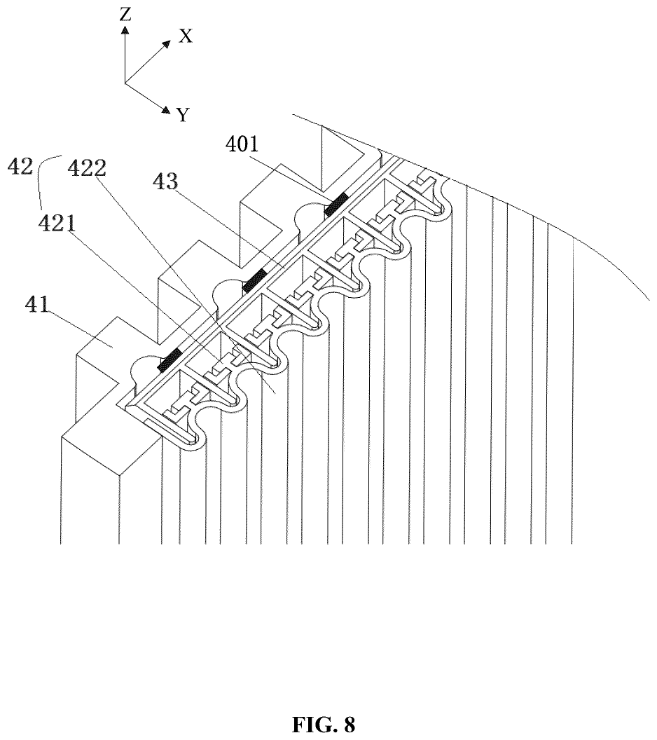

FIG. 8 is a schematic diagram of an original state of an elastic arc panel according to some embodiments of the present disclosure.

In some embodiments, as shown in FIG. 8, the adjustable sub plate 42 includes a plurality of T-shaped posts 421 and an elastic arc panel 422. The plurality of T-shaped posts 421 are provided are distributed on one side of the elastic arc panel 422. Each of the T-shaped posts 421 is clamped in the spacing between the two L-shaped baffles. The elastic arc panel 422 is located at an outer side of the base master plate 41. The pushing element 43 is inserted into the gap 413 and passes through a gap between adjacent limiting posts 412 to abut against the elastic arc panel 422.

The T-shaped posts 421 are configured to support the adjustable sub plate 42 and connect the adjustable sub plate 42 to the L-shaped baffles. The T-shaped posts 421 may be made of metal (e.g., steel, aluminum alloy) or engineering plastic.

The elastic arc panel 422 is configured to adjust the specimen interface morphology through deformation of an arc-shaped curved surface. The elastic arc panel 422 is made of an elastic material, for example, spring steel or engineering plastic. A strength of the elastic arc panel 422 is lower than strengths of the T-shaped posts 421. In some embodiments, when the elastic arc panel 422 is not subjected to a pushing action of the pushing element 43, a surface of the elastic arc panel 422 is the arc shape in a wavy form. After the elastic arc panel 422 is subjected to the pushing action of the pushing element 43, a curvature of the surface of the elastic arc panel 422 changes or the surface of the elastic arc panel 422 becomes the sawtooth shape. In some embodiments, the elastic arc panel 422 is connected to the T-shaped posts 421. The T-shaped posts 421 may be integrally formed with the elastic arc panel 422. The T-shaped posts 421 and the elastic arc panel 422 may also be separately manufactured and then fixed by welding, bolting, or snap-fitting. In some embodiments, two ends of the elastic arc panel 422 are fixed to the base master plate 41 by bonding, welding, or the like.

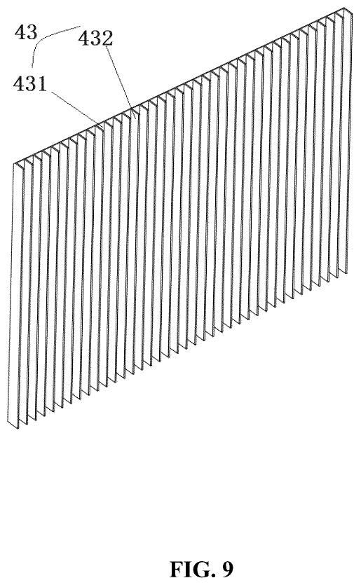

FIG. 9 is a schematic diagram of a structure of a pushing element according to some embodiments of the present disclosure.

In some embodiments, as shown in FIG. 9, the pushing element 43 includes a flat plate 431 and a plurality of pushing plates 432. The plurality of pushing plates 432 are uniformly arranged on one side of the flat plate 431, and a top portion of another side of the flat plate 431 is configured as a smooth arc surface. The flat plate 431 is inserted in the gap 413, each of the plurality of pushing plates 432 passes through a gap between two adjacent limiting posts 412, and an end of the pushing plate 432 abuts against the elastic arc panel 422.

In some embodiments of the present disclosure, the adjustable sub plate includes the T-shaped posts and the elastic arc panel, and each T-shaped post is engaged in the spacing of the L-shaped baffles, thereby providing stable support and precise guidance. The plurality of T-shaped posts are distributed on one side of the elastic arc panel, thereby enhancing overall load-bearing capacity and positioning accuracy of the adjustable sub plate. The pushing element passes through the gap between the limiting posts and abuts against the elastic arc panel, thereby achieving effective adjustment of the elastic arc panel. Adjustment accuracy and positional stability of the fabrication mold during a fabrication process are significantly improved through stable engagement of the T-shaped posts and flexible adjustment of the elastic arc panel, combined with a fine action of the pushing element, thereby improving quality of a machined workpiece and service life of the fabrication mold.

In some embodiments, as shown in FIG. 8, a plurality of linear actuators 401 are disposed inside the base master plate 41. The plurality of linear actuators 401 are respectively connected to the pushing element 43. The plurality of linear actuators 401 correspond one-to-one to a plurality of regions into which the elastic arc panel 422 is divided along a length direction of the elastic arc panel 422 (e.g., an X-axis direction).

The linear actuators 401 are configured to convert a control signal into a linear pushing or a retracting action of the pushing element 43. The linear actuator 401 may be a miniature linear stepper motor or a miniature servo electric cylinder.

In some embodiments, the plurality of linear actuators 401 are uniformly spaced along a length direction of the pushing element 43 (e.g., the X-axis direction). The elastic arc panel 422 is uniformly divided into the plurality of regions along the length direction (e.g., a positive direction of the X-axis). A length of each region along the length direction (e.g., the positive direction of the X-axis) may be preset based on requirements or experience. Each region corresponds to at least one pushing plate 432 (i.e., at least one pushing plate 432 pushes the elastic arc panel 422 in the region to deform).

In some embodiments, an output end of each linear actuator 401 is fixedly connected to the pushing element 43. A driving direction of the linear actuator 401 is perpendicular to a length direction of an elastic arc panel 422, so that a linear output of the linear actuator 401 can be converted into a pushing effect or a supporting effect of the pushing element 43 on the elastic arc panel 422.

In some embodiments, the linear actuators 401 are configured to apply output thrusts to a plurality of regions of the elastic arc panel 422. By controlling a magnitude of the output thrusts of the linear actuators 401, the elastic arc panel 422 may be changed from an arc shape to a sawtooth shape, or the elastic arc panel 422 may form an arc-shaped interface morphology with different arc curvatures. The magnitude of the output thrust is positively correlated with the arc curvature of the elastic arc panel 422. The arc curvature may be preset according to requirements. During a process of pouring the NC (or referred to a process of adding the NC), the linear actuators 401 maintain the output thrusts to the pushing element 43.

In some embodiments, the linear actuators 401 may be configured to apply preload forces to a plurality of regions of the elastic arc panel 422. Descriptions regarding the preload force may be found in related content below.

The plurality of linear actuators are arranged inside the base master plate and respectively drive corresponding regions of the pushing element, so that the elastic arc panel can continuously obtain stable thrust support during the NC pouring process, thereby reducing a risk of the interface morphology receding or becoming unstable due to a lateral force of slurry.

Fabrication of UHPC-NC specimens with a rectangular morphology and the arc-shaped morphology can be achieved using the fabrication mold described above. According to experimental requirements for various interface morphologies of UHPC-NC specimens, an interface adjustment member 6 is further provided in the present disclosure.

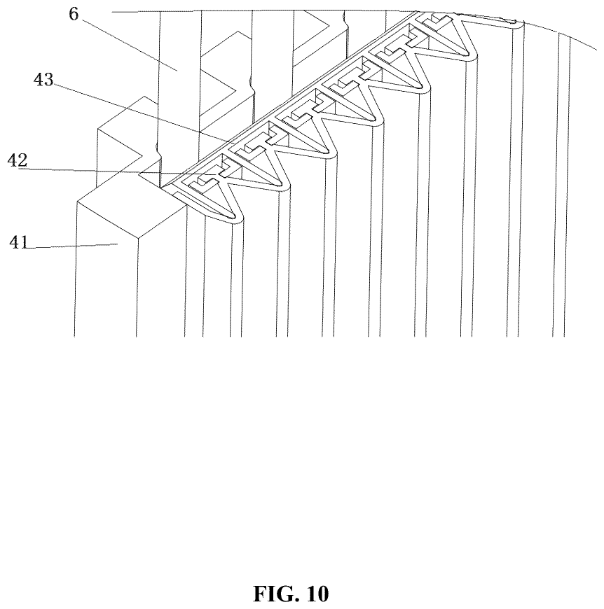

FIG. 10 is a schematic diagram of an elastic arc panel changing from an arc shape to a sawtooth shape according to some embodiments of the present disclosure.

In some embodiments, as shown in FIG. 10, the fabrication mold further includes the interface adjustment member 6. When an interface morphology of the adjustable sub plate 42 needs to be changed, the interface adjustment member 6 is movably inserted into the base master plate 41. The interface adjustment member 6 pushes the pushing element 43 to move toward the elastic arc panel 422, and the elastic arc panel 422 is pushed to deform from an arc shape into a sawtooth shape. In the present embodiment, the fabrication mold is not provided with the linear actuators 401.

The interface adjustment member 6 is configured to change the interface morphology of the adjustable sub plate 42.

In some embodiments, the interface morphology of the adjustable sub plate 42 is changed via the interface adjustment member 6, thereby transforming the elastic arc panel 422 into a sawtooth-shaped panel, so that fabrication of a UHPC-NC specimen with a sawtooth-shaped interface morphology is achieved.

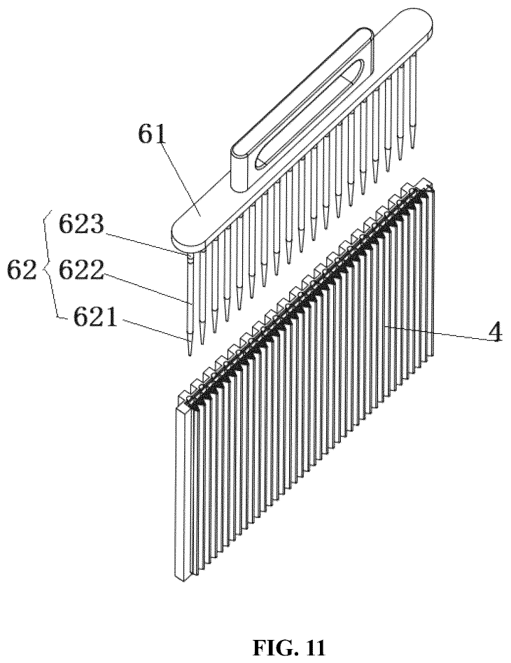

FIG. 11 is a schematic diagram of a cooperation relationship between an interface adjustment member and an interface partition plate according to some embodiments of the present disclosure.

In some embodiments, as shown in FIG. 11, the interface adjustment member 6 includes a cover plate 61 and a plurality of insertion rods 62.

The cover plate 61 is configured to provide a hand-held and supporting function during operation. The insertion rods 62 are inserted into the base master plate 41 and push the pushing element 43, thereby causing deformation of the elastic arc panel 42.

In some embodiments, the plurality of insertion rods 62 are uniformly connected to a bottom portion of the cover plate 61. A top portion of the cover plate 61 is provided with a handle to facilitate gripping when placing the insertion rods 62 into the gaps 413.

In some embodiments, each of the plurality of insertion rods 62 is integrally formed from bottom to top by a cone 621, a first cylinder 622, and a second cylinder 623. A variable-diameter transition section is provided between the first cylinder 622 and the second cylinder 623. A diameter of the first cylinder 622 is smaller than a diameter of the second cylinder 623. A side of the base master plate 41 near the rectangular protrusions 411 of the pushing element 43 is provided with a plurality of arc-shaped long grooves. The diameter of the second cylinder 623 is adapted to a diameter of each of the plurality of arc-shaped long grooves. After the interface adjustment member 6 is inserted into the base master plate 41, at least a portion of the second cylinder 623 is located in the arc-shaped long groove. When the UHPC-NC specimen with the sawtooth-shaped interface morphology needs to be fabricated, the interface adjustment member 6 is movably inserted into the base master plate 41, the insertion rods 62 push the pushing element 43 to move toward the elastic arc panel 422, and the pushing plates 432 cause the elastic arc panel 422 to deform from the arc shape into a sawtooth shape. When the insertion rods 62 are inserted to bottom portions of the gaps 413, the second cylinders 623 cooperate with the arc-shaped long grooves to tightly abut against the pushing element 43.

The adjustable sub plate is pushed and squeezed by the insertion rods to deform into a sawtooth shape during a process of inserting the interface adjustment member into the interface partition plate, and the deformed interface partition plate is used to fabricate the sawtooth-shaped interface morphology. In general, fabrication mold is used to fabricate UHPC-NC specimens with three different interface morphologies, which is beneficial for later testing of splitting tensile strengths of UHPC-NC specimens under different interface morphologies, thereby obtaining more comprehensive performance analysis results for UHPC-NC specimens.

In some embodiments of the present disclosure, controllable deformation of the elastic arc panel from the arc shape to the sawtooth shape is achieved through flexible insertion of the interface adjustment member, so that the interface morphology of the adjustable sub plate can be changed quickly and conveniently. The design significantly improves adaptability and production efficiency of the mold, thereby effectively reducing downtime and cost, and making the mold suitable for fabrication requirements of diversified products.

Some embodiments of the present disclosure further provide a fabrication method for a UHPC-NC specimen. The fabrication method uses the fabrication mold described above to complete fabrication of UHPC-NC specimens with different interface morphologies.

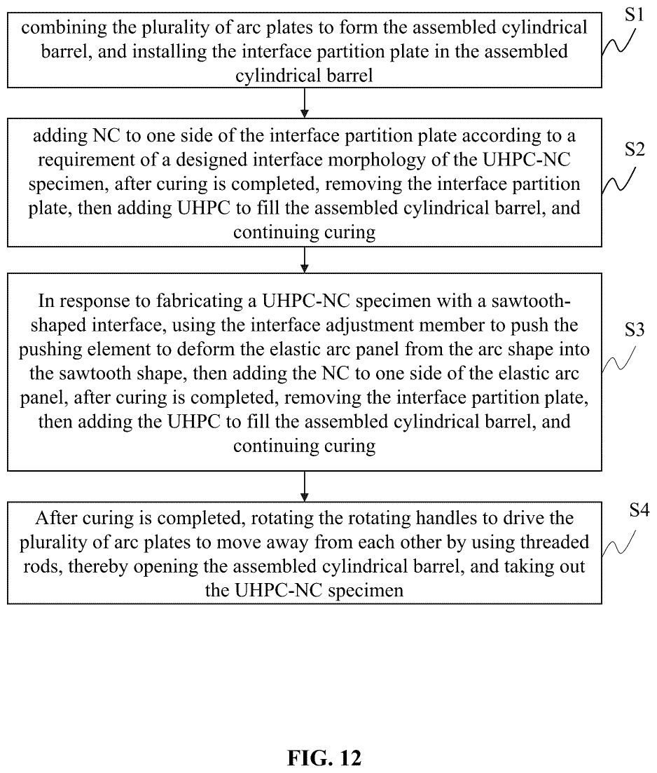

FIG. 12 is a flowchart illustrating an exemplary process of a fabrication method for a UHPC-NC specimen according to some embodiments of the present disclosure. In some embodiments, as shown in FIG. 12, the fabrication method for the UHPC-NC specimen includes operation S1 to operation S4.

In S1, the plurality of arc plates are combined to form the assembled cylindrical barrel, and the interface partition plate is installed in the assembled cylindrical barrel.

In some embodiments, the detachable assemblies 5 (e.g., rotating the rotating handles 531 of the regulators 53) are adjusted, so that a plurality of arc plates 21 (e.g., three arc plates 21) are brought close to each other and tightly assembled to form the assembled cylindrical barrel 2. The interface partition plate 4 is inserted into the assembled cylindrical barrel 2 and engaged in a clamping groove 111 on a circular boss 11.

In S2, normal concrete (NC) is added to one side of the interface partition plate according to a requirement of a designed interface morphology of the UHPC-NC specimen, after curing is completed, the interface partition plate is removed, then ultra-high performance concrete (UHPC) is added to fill the assembled cylindrical barrel, and curing is continued.

The requirement of the designed interface morphology refers to a preset morphology characteristic of an interface between UHPC and NC materials during design of the UHPC-NC specimen. For example, the designed interface morphology may be a rectangular interface, an arc-shaped interface, a sawtooth-shaped interface, or the like.

The one side of the interface partition plate 4 may be a side of the base master plate 41 or a side of the adjustable sub plate 42. The side of the base master plate 41 is used to form a predetermined specimen interface morphology (e.g., a rectangular interface). The side of the adjustable sub plate 42 is used to form a variable specimen interface morphology (e.g., an arc-shaped interface and a sawtooth-shaped interface).

For example, according to an interface morphology of the UHPC-NC specimen to be fabricated, a left-side region of the interface partition plate 4 (the side of the base master plate 41) or a right-side region of the interface partition plate 4 (the side of the adjustable sub plate 42) is selected to add pre-prepared NC (with a specific mix proportion shown in Table 1). A layer of release agent may be applied to the side of the interface partition plate 4 where the material is to be added before adding. The release agent may be Vaseline or the like. The mold is placed in a curing chamber for curing according to a preset condition. The preset condition may be set according to requirements or experience. For example, the preset condition may be curing for 28 days with a curing temperature of 20° C.±2° C. and a relative humidity of 95%. After curing is completed, the interface partition plate 4 is removed, and the mold is filled with the prepared UHPC (with a specific mix proportion shown in Table 2); and the mold is placed in the curing chamber again for curing according to the preset condition.

TABLE 1
mix proportion of NC (kg/m³)

| | | | | | | Water- |
|---|---|---|---|---|---|---|
| Strength | | | | | Water | cement |
| grade of NC | Cement | Water | Sand | Stone | reducer | ratio |
| C40 | 396 | 178 | 683 | 1164 | 3.96 | 0.45 |

TABLE 2
mix proportion of the UHPC (kg)

| UHPC | | End-hooked | Long straight | Water |
|---|---|---|---|---|
| powder | Water | steel fiber | fiber | reducer |
| 25 | 2.05 | 0.94 | 0.94 | 0.22 |

In S3, in response to fabricating a UHPC-NC specimen with a sawtooth-shaped interface, the interface adjustment member is used to push the pushing element to deform the elastic arc panel from the arc shape into the sawtooth shape, then the NC is added to one side of the elastic arc panel, after curing is completed, the interface partition plate is removed, then the UHPC is added to fill the assembled cylindrical barrel, and curing is continued.

In some embodiments, as shown in FIG. 8, an original form of the interface partition plate 4 may be used to fabricate the UHPC-NC specimen with the rectangular interface or the arc-shaped interface. If a UHPC-NC specimen with the sawtooth-shaped interface needs to be fabricated, the interface adjustment member 6 is required. An operator grips a handle of the cover plate 61 to insert insertion rods 62 into corresponding arc-shaped long grooves. During a downward insertion process of the insertion rods 62, the insertion rods 62 push a flat plate 431 to move, so that the pushing plates 432 connected to another side of the flat plate 431 push the elastic arc panel 422 to cause the elastic arc panel 422 to deform from an arc-shaped surface to a sawtooth shape, as shown in FIG. 10. When the insertion rods 62 are inserted into bottom portions of the gaps 413, the second cylinders 623 cooperate with the arc-shaped long grooves to tightly press against the pushing element 43, thereby preventing the deformed sawtooth-shaped panel from automatically recovering under the action of the elastic rubber columns 7.

In S4, after curing is completed, the rotating handles are rotated to drive the plurality of arc plates to move away from each other by using threaded rods, thereby opening the assembled cylindrical barrel, and the UHPC-NC specimen is taken out.

In some embodiments, after curing is completed, the UHPC-NC specimen is formed. The rotating handles 531 are rotated to drive the threaded rods 532 to rotate and gradually separate the UHPC-NC specimen. Because the connecting discs 533 are mounted on the arc plates 21, the connecting discs 533 rotate synchronously with the threaded rods 532 to drive the arc plates 21 to move in a direction away from the UHPC-NC specimen, thereby enabling the UHPC-NC specimen to achieve rapid demolding. After fabrication of the UHPC-NC specimen is completed, the UHPC-NC specimen is adjusted. For example, two ends of the UHPC-NC specimen are cut off by 1/7 of an overall height of the UHPC-NC specimen, thereby eliminating an influence of uneven aggregate distribution and pitted surfaces at end faces on subsequent tests, and a final height of the UHPC-NC specimen is 50 mm.

According to the fabrication method described above, three types of UHPC-NC specimens with morphologies required for tests are fabricated: a rectangular interface (specimen one, also referred to as rectangular bonding interface), an arc-shaped interface (specimen two, also referred to as arc-shaped bonding interface), and a sawtooth-shaped interface (specimen three, also referred to as sawtooth-shaped bonding interface). Merely by way of example, in a freeze-thaw environment in Jiuquan City, Gansu Province, a dynamic splitting tensile strength test of interfaces under influence of freeze-thaw damage is performed for UHPC-NC specimens with different interface morphologies according to the following manner, specifically as follows.

First, the UHPC-NC specimen is subjected to freeze-thaw cycle erosion for a freeze-thaw cycle count, which is determined based on a freeze-thaw deterioration proportion coefficient.

The freeze-thaw deterioration proportion coefficient Kₐ is introduced, with a value of 12. A local annual freeze-thaw cycle count in the Jiuqua region of Gansu is 100 to 130, 115 is taken as an annual freeze-thaw count, thus an indoor freeze-thaw cycle count within one year is N115/Kₐ≈10. Every 5 years is taken as a cycle, a deterioration situation of dynamic splitting tensile strength of a UHPC-NC bonding interface is considered, and the freeze-thaw cycle count is set to 0, 50, 100, 150, and 200, respectively. Combined with temperature in western regions, 25° C. is selected as a highest temperature to simulate summer temperature, −20° C. is selected to simulate a lowest winter temperature, a constant temperature is maintained at the lowest temperature for 2 hours, and a constant temperature is maintained at the highest temperature for 1 hour to allow moisture to fully freeze and melt.

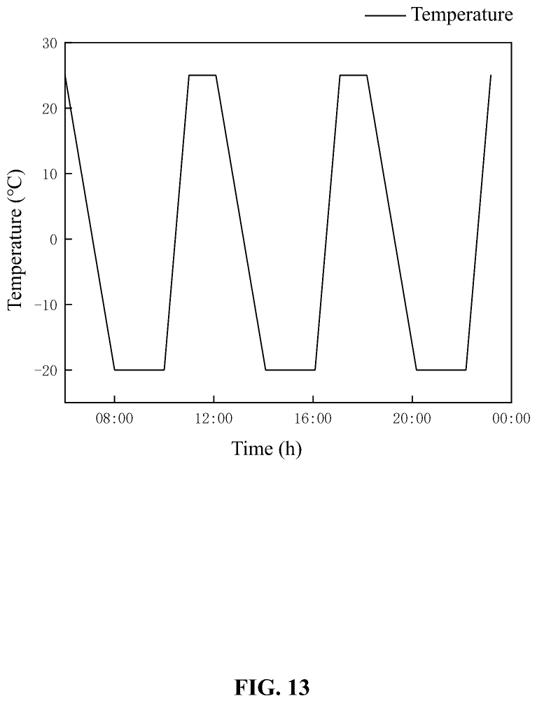

FIG. 13 is a schematic diagram of a temperature rise and fall mechanism and a duration of high temperature and low temperature according to some embodiments of the present disclosure. The temperature rise and fall mechanism and the duration of a high temperature and a low temperature as shown in FIG. 13 are set, the UHPC-NC specimen is subjected to freeze-thaw cycle erosion. According to environmental conditions and test requirements in western region, the temperature rise and fall mechanism and the duration of the high temperature and the low temperature are set. The freeze-thaw cycle erosion includes a spraying stage, a cooling stage, a low-temperature constant temperature stage, a heating stage, and a high-temperature constant temperature stage, and durations of each stage are 5 minutes, 2 hours, 2 hours, 1 hour, and 1 hour, respectively, totaling 6 hours and 5 minutes.

Then, the UHPC-NC specimen after the freeze-thaw cycle erosion are placed on a split Hopkinson pressure bar (SHPB) test bench. A bonding interface of the UHPC-NC specimen and a center of an incident bar are placed on a same horizontal plane, the incident bar and a transmitted bar are utilized to clamp the UHPC-NC specimen, and different impact air pressure levels are set to perform impact tests on the UHPC-NC specimen.

After the UHPC-NC specimen undergoes the above processing, the UHPC-NC specimen is placed on the SHPB test bench. The incident bar 8 and the transmitted bar 9 are utilized to clamp the UHPC-NC specimen, a strain gauge 20 is disposed on the transmitted bar 9, and the strain gauge 20 captures transmitted wave of the transmitted bar 9. A rigid pad strip is disposed at a contact surface among the incident bar 8, the transmitted bar 9, and the UHPC-NC specimen, and a curvature of the rigid pad strip matches an outer wall of the UHPC-NC specimen, thereby avoiding damage at a stress point of the UHPC-NC specimen due to stress concentration. Different impact air pressure levels are set to perform impact tests, a greater impact air pressure increases a dynamic splitting tensile strength of a bonding interface of the UHPC-NC specimen (i.e., a strain rate effect). Based on actual laboratory conditions and to ensure that specimen is destroyed under dynamic impact, corresponding gradients are set. Merely by way of example, the impact air pressure in the present disclosure is set to a value from 0.1 MPa to 0.15 MPa.

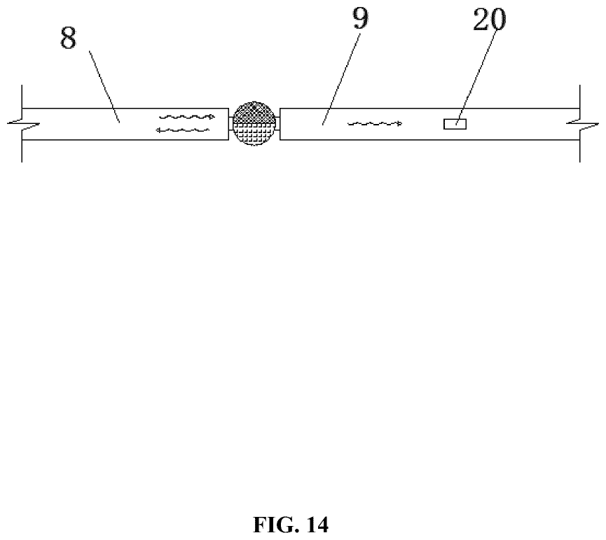

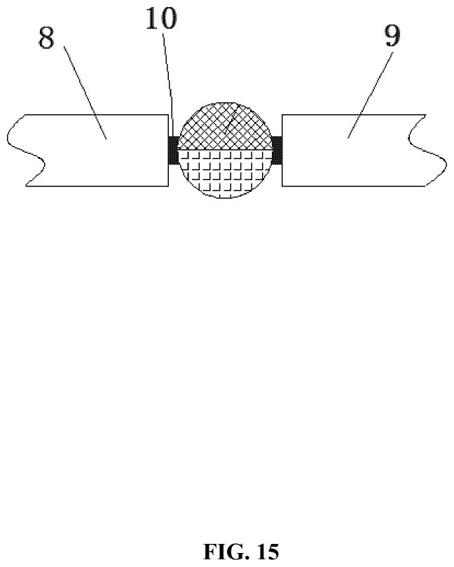

FIG. 14 is a schematic diagram of clamping of a UHPC-NC specimen on a SHPB test bench according to some embodiments of the present disclosure. FIG. 15 is a schematic diagram of a partial enlarged structure of a UHPC-NC specimen during loading according to some embodiments of the present disclosure.

In some embodiments, as shown in FIG. 14 and FIG. 15, a SHPB test loading device of a straight-tapered variable cross-section with a diameter of 74 mm is adopted. An elastic modulus of a rigid pad strip 10 is 210 GPa, an elastic wave velocity in the rigid pad strip 10 is 5172 m/s, and a density of the rigid pad strip 10 is 7850 kg/m³. A length of the incident bar 8 is 3.2 m and a length of the transmitted bar 9 is 1.8 m. The UHPC-NC specimen is placed on the SHPB test bench, a UHPC-NC bonding interface and a center of the incident bar are placed in a same horizontal plane, and the incident bar 8 and the transmitted bar 9 are utilized to clamp the UHPC-NC specimen. The rigid pad strip 10 is disposed at a contact surface among the incident bar 8, the transmitted bar 9, and the UHPC-NC specimen, and a curvature of the rigid pad strip matches an outer wall of the UHPC-NC specimen. The clamping manner is as shown in FIG. 14, impact air pressures of 0.1 MPa, 0.125 MPa, and 0.15 MPa are respectively set to perform impact tests on the UHPC-NC specimen.

During the impact test, a stress wave is transmitted to the UHPC-NC specimens through the rigid pad strip 10. An interface crack initiation point occurs at a center of the UHPC-NC specimen, so that the stress wave causes a main crack perpendicular to a loading direction to appear at the center of the UHPC-NC specimen, and the main crack expands toward both sides to split the UHPC-NC specimen into two parts.

To ensure reliability of test data, the SHPB impact splitting test needs to satisfy two basic assumptions: (1) one-dimensional elastic wave assumption: the incident bar 8 and the transmitted bar 9 remain within an elastic range during the test, and propagation of stress waves in the incident bar 8 and the transmitted bar 9 is approximately regarded as one-dimensional waves; and (2) uniformity assumption: stress and strain in the specimen are uniformly distributed along a length of the specimen during the test.

According to a propagation principle of one-dimensional elastic waves, a displacement u₈(t) at an end face of the incident bar 8 is:

$${u}_{8} ( t ) = {C}_{0} {\int }_{0}^{t} {ε}_{i} ( t ) - {ε}_{r} ( t ) d t .$$

Because a displacement at an end face of the transmitted bar 9 is only related to transmitted wave, a displacement u₉(t) at the end face of the transmitted bar 9 is:

$${u}_{9} ( t ) = {C}_{0} {\int }_{0}^{t} {ε}_{t} ( t ) d t .$$

By subtracting the displacement u₉(t) at the end face of the transmitted bar 9 from the displacement u₈(t) at the end face of the incident bar 8, an overall displacement uₛ of the specimen is obtained as follows:

$${u}_{s} = {u}_{8} ( t ) - {u}_{9} ( t ) .$$

A load P₈(t) at an end face of the incident bar 8 and a load P₉(t) at an end face of the transmitted bar 9 are respectively expressed as follows:

$${P}_{8} ( t ) = {E}_{0} {A}_{0} [ {ε}_{i} ( t ) + {ε}_{r} ( t ) ] ,$$

$${P}_{9} ( t ) = {E}_{0} {A}_{0} {ε}_{t} ( t ) .$$

Therefore, an average load P(t) borne by two ends of the specimen is as follows:

$$P ( t ) = {E}_{0} {A}_{0} \frac{{ε}_{i} ( t ) + {ε}_{r} ( t ) + {ε}_{t} ( t )}{2} .$$

According to equilibrium assumption, i.e., εᵢ(t)+εᵣ(t)=εₜ(t), it can be derived that:

$$P ( t ) = {E}_{0} {A}_{0} {ε}_{t} ( t ) .$$

In the above formulas: C₀ denotes a wave velocity, εᵢ(t) denotes an incident wave, εᵣ(t) denotes a reflected wave, εₜ(t) denotes a transmitted wave, t denotes time, P₈(t) denotes a load borne by an end surface of the incident bar 8, P₉(t) denotes a load borne by an end surface of the transmitted bar 9, P(t) denotes a load borne by the UHPC-NC specimen, A₀ and E₀ respectively denotes a cross-sectional area and an elastic modulus of a pressure bar (i.e., the incident bar 8 and the transmitted bar 9) of the SHPB test loading device.

In some embodiments, data of the transmitted wave needs to be captured to measure a dynamic splitting tensile strength of the specimen. After the strain gauge 20 obtains an electrical signal, the strain gauge 20 collects experimental data through a strain gauge, and the transmitted wave is obtained after data processing. In the present embodiment, the strain gauge is a super dynamic strain gauge of model SDY2107B produced by Beidaihe Practical Electronic Technology Research Institute.

Finally, the dynamic splitting tensile strength of the UHPC-NC specimen is calculated according to the load borne by the UHPC-NC specimen.

For experimental data analysis of the UHPC-NC specimen after applying the impact air pressure, first, the load borne by the UHPC-NC specimen is calculated according to the formula P(t)=E₀A₀εₜ(t).

Then, the dynamic splitting tensile strength of the UHPC-NC specimen is calculated according to the obtained load borne by the UHPC-NC specimen, and a calculation formula for the dynamic splitting tensile strength is as follows:

$${f}_{dtn} = \frac{2 {P ( t )}_{max}}{π {D}_{1} L} .$$

In the formula, f_{dtn} denotes the dynamic splitting tensile strength of the UHPC-NC specimen, P(t)ₘₐₓ denotes a maximum load borne by the UHPC-NC specimen, n denotes a count of freeze-thaw cycles, D₁ denotes an inner diameter of the self-made mold, and L denotes a height of the UHPC-NC specimen.

In the present embodiment, splitting tensile strength tests are performed on the specimen one, specimen two, and specimen three after freeze-thaw cycle erosion, respectively, n takes values of 0, 50, 100, 150, and 200, respectively, D₁=100 mm, and L=50 mm. Under impact air pressures of 0.1 MPa, 0.125 MPa, and 0.15 MPa, splitting tensile strengths of the UHPC-NC specimens with three different interface morphologies are obtained through calculation, and results are shown in Table 3, Table 4, and Table 5, respectively.

TABLE 3
dynamic splitting tensile strength of UHPC-NC specimen
with rectangular bonding interface (specimen one)

| Count of freeze- | Dynamic splitting | Impact air |
|---|---|---|
| thaw cycles | tensile strength/MPa | pressure/MPa |
| 0 | 14.3 | 0.1 |
| | 17.5 | 0.125 |
| | 19.1 | 0.15 |
| 50 | 12.8 | 0.1 |
| | 15.8 | 0.125 |
| | 17.8 | 0.15 |
| 100 | 9.5 | 0.1 |
| | 11.8 | 0.125 |
| | 13.7 | 0.15 |
| 150 | 6.9 | 0.1 |
| | 9.1 | 0.125 |
| | 10.6 | 0.15 |
| 200 | 5.3 | 0.1 |
| | 5.9 | 0.125 |
| | 6.5 | 0.15 |

TABLE 4
dynamic splitting tensile strength of UHPC-NC specimen
with arc-shaped bonding interface (specimen 2)

| Count of freeze- | Dynamic splitting | Impact air |
|---|---|---|
| thaw cycles | tensile strength/MPa | pressure/MPa |
| 0 | 14.2 | 0.1 |
| | 16.7 | 0.125 |
| | 18.3 | 0.15 |
| 50 | 12.3 | 0.1 |
| | 15.3 | 0.125 |
| | 17.3 | 0.15 |
| 100 | 8.5 | 0.1 |
| | 10.2 | 0.125 |
| | 12.3 | 0.15 |
| 150 | 5.9 | 0.1 |
| | 8.3 | 0.125 |
| | 9.3 | 0.15 |
| 200 | 4.4 | 0.1 |
| | 4.8 | 0.125 |
| | 5.2 | 0.15 |

TABLE 5
dynamic splitting tensile strength of UHPC-NC specimen
with sawtooth-shaped bonding interface (specimen three)

| Count of freeze- | Dynamic splitting | Impact air |
|---|---|---|
| thaw cycles | tensile strength/MPa | pressure/MPa |
| 0 | 16.3 | 0.1 |
| | 18.9 | 0.125 |
| | 21.3 | 0.15 |
| 50 | 13.9 | 0.1 |
| | 17.2 | 0.125 |
| | 20.1 | 0.15 |
| 100 | 11.2 | 0.1 |
| | 13.2 | 0.125 |
| | 15.3 | 0.15 |
| 150 | 8.3 | 0.1 |
| | 10.3 | 0.125 |
| | 11.2 | 0.15 |
| 200 | 6.2 | 0.1 |
| | 6.9 | 0.125 |
| | 7.5 | 0.15 |

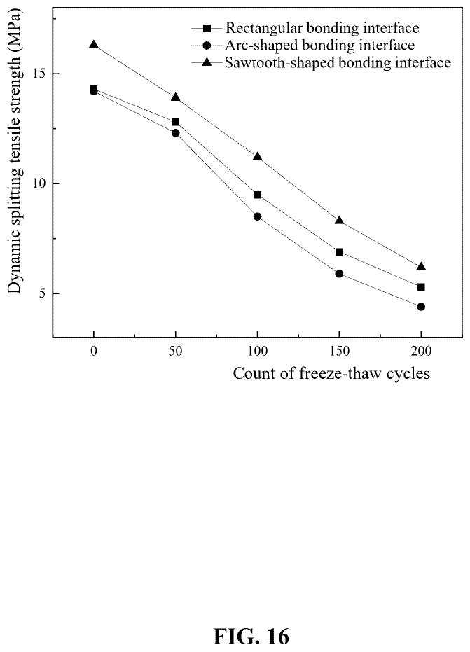

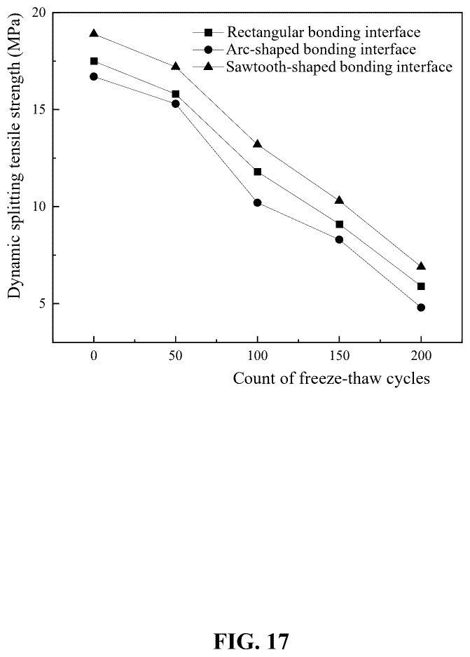

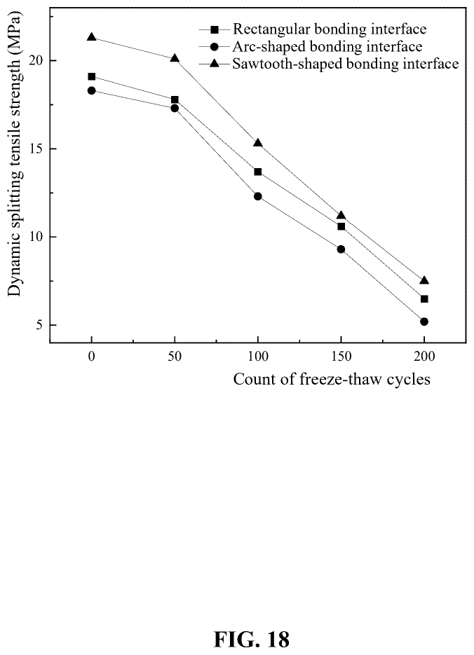

FIG. 16 is a point-line diagram of dynamic splitting tensile strength of UHPC-NC specimens with three interface morphologies under different counts of freeze-thaw cycles and an impact air pressure of 0.1 MPa according to some embodiments of the present disclosure. FIG. 17 is a point-line diagram of dynamic splitting tensile strength of UHPC-NC specimens with three interface morphologies under different counts of freeze-thaw cycles and an impact air pressure of 0.125 MPa according to some embodiments of the present disclosure. FIG. 18 is a point-line diagram of dynamic splitting tensile strength of UHPC-NC specimens with three interface morphologies under different counts of freeze-thaw cycles and an impact air pressure of 0.15 MPa according to some embodiments of the present disclosure.

Comparative results of the dynamic splitting tensile strengths of interfaces under different interface morphologies are shown in FIG. 16 to FIG. 18. Analysis indicates that the specimen three (i.e., the UHPC-NC specimen with a sawtooth-shaped interface morphology) exhibits good performance in dynamic splitting tensile strength, and the performance of the specimen three is significantly higher than the performance of UHPC-NC specimens with a rectangular interface morphology and an arc-shaped interface morphology. Therefore, in practical engineering applications, the concrete interface to be repaired is processed into a sawtooth morphology, which is expected to effectively improve the structural strength after repair. This has non-negligible practical significance for improving the overall quality of engineering projects and ensuring long-term stable operation of engineering projects and can provide valuable reference and guidance for practical engineering practices.

In some embodiments, during a process of adding the NC, a displacement magnitude and/or a lateral force of the pushing element 43 are obtained by using at least one of a displacement sensor and/or a pressure sensor disposed on the pushing element 43. The pushing element 43 is controlled to perform a compensation adjustment based on the displacement magnitude and/or the lateral force. Applicable scenarios for the compensation adjustment above include: the interface morphology of an arc shape, or the interface morphology of an arc shape or a sawtooth shape, and the pushing element 43 is only driven by the linear actuators 401.

In some embodiments, the displacement magnitude and/or the lateral force of the pushing element 43 reflect a displacement magnitude or a lateral force experienced by the elastic arc panel 422 during the process of adding the NC.

In some embodiments, one or more displacement sensors and/or one or more pressure sensors may be provided.

In some embodiments, when only overall monitoring of a deformation trend of the elastic arc panel 422 is required, a single displacement sensor and/or a single pressure sensor may be provided.

In some embodiments, when monitoring of deformation or force of different regions on a surface of the elastic arc panel 422 is required, a plurality of displacement sensors and/or a plurality of pressure sensors are provided. The plurality of displacement sensors and/or the plurality of pressure sensors are distributed and disposed on a side of the pushing element 43 facing the base master plate 411 along a length direction (e.g., an X-axis direction) of the pushing element 43. Each sensor is attached to or fixedly connected with the pushing element 43. The plurality of displacement sensors and/or the plurality of pressure sensors respectively correspond to different regions of the elastic arc panel. More descriptions regarding the regions and the division manner of the regions may be found in FIG. 6 and FIG. 7 and related descriptions.

The displacement magnitude of the pushing element 43 refers to displacement magnitude of the pushing element 43 in a normal direction (e.g., a Y-axis direction). The lateral force refers to a force generated by NC slurry during the process of adding the NC and acting on the elastic arc panel 422 along a normal direction of the elastic arc panel (e.g., a negative direction of the Y-axis).

In some embodiments, the displacement magnitude is obtained through the displacement sensor. The acceleration may be determined by obtaining a displacement velocity at a start moment of a preset time period and a displacement velocity at an end moment of the preset time period. The acceleration may be calculated using an acceleration formula and the acceleration formula is shown below:

$$a = ( {v}_{2} - {v}_{1} ) / t .$$

In the formula, a denotes the acceleration, v₁ denotes the displacement velocity at the start moment of the preset time period, v₂ denotes the displacement velocity at the end moment of the preset time period, and t denotes a duration of the preset time period.

In some embodiments, the lateral force is obtained through the pressure sensor. A pressure change trend is determined based on time and the lateral force using a formula (F₁−F₂)/t, where F₁ denotes a lateral force at the start moment of the preset time period, and F₂ denotes a lateral force at the end moment of the preset time period.

In some embodiments, the pushing element 43 may perform compensation adjustment in various ways based on an actual deformation state.

In some embodiments, in response to a determination that the displacement magnitude collected by the displacement sensor is greater than a deviation threshold, the pushing element 43 is controlled to push the elastic arc panel 422 along a pushing direction (e.g., a positive direction of the Y-axis) to perform compensatory pushing. The compensatory pushing is repeated until the displacement magnitude is less than the deviation threshold. The deviation threshold may be preset based on experience or requirements.

In some embodiments, a compensatory interval between adjacent compensatory pushing is determined by looking up a preset table based on the acceleration. The compensatory interval refers to a time interval between adjacent compensatory pushing. The preset table includes a mapping relationship between the acceleration and the compensatory interval. The mapping relationship may be set based on experience.

In some embodiments, in response to a determination that the lateral force collected by the pressure sensor is greater than a preset threshold, the pushing element 43 is controlled to increase a supporting force to counteract the lateral force. The preset threshold may be preset based on requirement or experience. The supporting force refers to a thrust with which the pushing element 43 supports the elastic arc panel 422 against deformation along a retreating direction (e.g., a negative direction of the Y-axis).

During the process of adding the NC, the displacement magnitude of the pushing element is obtained in real time through the displacement sensor, and compensation adjustment of the pushing element is performed accordingly. The compensation adjustment timely adjusts a situation where the interface morphology deforms, so that the interface morphology remains within the requirement of the designed interface morphology along with displacement during the pouring process, thereby improving stability of interface morphology formation. Obtaining the lateral force through the pressure sensor can monitor a force condition and a deformation trend of the elastic arc panel, and the compensation adjustment can prevent a risk of deformation of the interface morphology.

In some embodiments, the compensation adjustment further includes: performing the compensation adjustment on the pushing element 43 based on the plurality of linear actuators 401 inside the base master plate 41.

In some embodiments, the plurality of linear actuators 401 correspond one-to-one to a plurality of regions of the elastic arc panel 422 divided along a length direction (e.g., an X-axis direction). Each region corresponds to at least one pushing plate 432 (i.e., at least one pushing plate 432 pushes the elastic arc panel 422 in the region to deform). In some embodiments, each linear actuator 401 performs compensation adjustment on at least one pushing plate 432 of a corresponding region.

In some embodiments, for each linear actuator 401, the linear actuator 401 may perform compensation adjustment by changing a working parameter. The working parameter includes at least one of an output displacement and an output thrust of the linear actuator 401. The output displacement refers to a displacement output by the linear actuator 401 to cause the pushing element 43 to move along a pushing direction. In some embodiments, the pushing element 43 connected to the linear actuator 401 may be displaced along the pushing direction by changing the output displacement of the linear actuator 401. The output thrust refers to a pushing force along the pushing direction output by the linear actuator 401. In some embodiments, a supporting force of the pushing element 43 on the elastic arc panel 422 may be increased by changing the output thrust of the linear actuator 401.

In some embodiments, in response to a determination that the displacement magnitude is greater than the deviation threshold, the output displacement of the linear actuator 401 is increased to drive the pushing element 43 to push toward the elastic arc panel 422, and the linear actuator 401 is controlled to stop increasing the output displacement and maintain a current output state until the displacement magnitude is less than or equal to the deviation threshold.

In some embodiments, in response to a determination that the lateral force is greater than the preset threshold, the output thrust of the linear actuator 401 is increased and the current output state is maintained, thereby increasing the supporting force of the pushing element 43 to counteract the lateral force.

The linear actuator arranged inside the base master plate is utilized to achieve compensation adjustment of the pushing element, so that deformation state feedback is directly converted into an actual pushing action of the pushing element, thereby improving responsiveness and execution reliability of the compensation adjustment.

In some embodiments, for the UHPC-NC specimen with the arc-shaped interface or the sawtooth-shaped interface, during a molding holding stage before adding NC, the plurality of linear actuators 401 drive the pushing element 43 to push toward the elastic arc panel 422, so that the elastic arc panel 422 is in a pre-stressed state. The plurality of linear actuators 401 correspond to a plurality of regions of the elastic arc panel 422, which are divided along a length direction of the elastic arc panel 422. The elastic arc panel 422 is subjected to different preload forces in different regions.

The molding holding stage refers to a stage after an interface morphology of the elastic arc panel is formed and before NC is poured, which is used to keep the elastic arc panel in the formed interface morphology (e.g., the arc-shaped interface or the sawtooth-shaped interface).

The preload force refers to a pushing force applied to the elastic arc panel 422 before adding NC. The preload force is less than a minimum thrust that causes the elastic arc panel 422 to displace. The pre-stressed state refers to a state where the elastic arc panel 422 is subjected to the preload force forces but does not displace.

More descriptions regarding a division manner of the regions of the elastic arc panel 422 may be found FIG. 8 and related descriptions.

In some embodiments, supporting forces applied by the pushing element 43 to different regions of the elastic arc panel 422 may be changed by increasing different output thrusts for different linear actuators 401, so that the elastic arc panel 422 is subjected to different preload forces in different regions. The output thrust is positively correlated with the preload force. For example, a value of the output thrust may be the same as a value of the preload force.

In some embodiments, the preload forces for the plurality of regions are determined by querying a preset preload force table based on the requirement of the designed interface morphology. The preset preload force table includes a mapping relationship between the designed interface morphology and the preload forces for the plurality of regions. The mapping relationship may be set according to requirements or experience. For example, a relatively large preload force is applied to a region in a middle portion of the elastic arc panel 422, and a relatively small preload force is applied to a region located at an edge of the elastic arc panel 422, and the preload force decreases from the middle toward the edge.

In some embodiments, a plurality of sensors and a plurality of linear actuators may be arranged at different depths (dimensions along a Z-axis direction) in a same region. In the preset preload force table, and the preload force is positively correlated with the depth.

Different preload forces are set for the pushing element in different regions during the molding holding stage, so that the elastic arc panel forms the pre-stressed state with uneven distribution along the length direction before entering an NC pouring stage, thereby improving an initial anti-disturbance capability of the interface morphology against subsequent lateral forces of slurry and reducing adjustment requirements during the pouring process.

In some embodiments, a processor is further arranged inside the fabrication mold. The processor may also be a remote processor external to the fabrication mold. The processor may include one or a combination of a microcontroller (MCU), an embedded processor, a graphics processing unit (GPU), or the like. The processor communicates with the displacement sensor, the pressure sensor, etc.

In some embodiments, the processor may be configured to construct a graph structure, and determine preload forces for the plurality of regions based on the graph structure via a prediction model.

The graph structure refers to a graphical structure reflecting relative positional relationships of the plurality of regions of the elastic arc panel 422.

Nodes of the graph structure are constructed based on the plurality of regions of the elastic arc panel 422, and edges of the graph structure are constructed based on relative positional relationships of the plurality of regions on the elastic arc panel.

In some embodiments, a node feature of the node includes position numbers of the plurality of regions, length proportions of the plurality of regions, an interface morphology type of the elastic arc panel 422 (e.g., the arc-shaped interface or the sawtooth-shaped interface), and a plurality of lateral force sequences of the plurality of regions during the process of adding the NC in historical tests. The position numbers of the plurality of regions increase or decrease along the length direction of the elastic arc panel 422. The lateral force sequence for each region may be sequence data of the historical lateral force of the region during the entire pouring process over time, which is collected by the pressure sensor. Using a start moment of the process of adding the NC as a unified time reference, the historical lateral force sequences collected in various tests are time-aligned or normalized; statistical processing is performed on the historical lateral force sequences obtained for a same region in multiple historical tests to determine a final lateral force sequence for the region. For example, an average value or a variance of historical lateral forces at each time point in the plurality of historical lateral force sequences of the region constitutes an element of the lateral force sequence of the region.

In some embodiments, edges of the graph structure may be constructed based on adjacent regions. In the case, the edges of the graph structure are not assigned weights, and the graph structure is an unweighted graph.

In some embodiments, edges of the graph structure may be constructed based on a distance of each region along the length direction (e.g., an X-axis direction) of the elastic arc panel 422. A weight of an edge is positively correlated with the distance.

The prediction model refers to a model for predicting the preload forces for the plurality of regions. In some embodiments, the prediction model is a graph neural network (GNN) model.

In some embodiments, the prediction model may be obtained by training a large number of training samples with labels. In some embodiments, the plurality of training samples with labels may be input into an initial prediction model, a loss function is constructed based on the labels and results of the initial prediction model, and parameters of the initial prediction model are iteratively updated based on the loss function via gradient descent or other manners. When a preset condition is met, model training is completed, resulting in a trained prediction model. The preset condition may be convergence of the loss function, an iteration count reaching a threshold, etc.

Each group of training samples in the training samples may include a sample graph structure in sample data. The training samples may be obtained from historical data in historical tests. A label corresponding to the training sample includes sample preload forces for the plurality of regions corresponding to each sample graph structures. The label may be historical preload force that achieves the best preload forcing effect for each region in each historical test. The preload forcing effect may be determined by the time for subsequent compensation adjustment. The later time for the subsequent compensation adjustment indicates a better preload forcing effect. More descriptions regarding the compensation adjustment may be found in the related description above.

In some embodiments of the present disclosure, the graph structure is constructed to represent the plurality of regions on the elastic arc panel and complex relative positional relationships among the plurality of regions, and the graph neural network model is used as the prediction model to determine the preload forces of the plurality of regions, which can effectively capture structural and mechanical coupling relationships among the plurality of regions, thereby improving accuracy and efficiency of predicting the preload forces, helping to enhance stability of interface morphology formed by the elastic arc panel, improving fabrication quality of the specimen, reducing deformation errors, and extending a service life.

Basic concepts have been described above. Obviously, for a person skilled in the art, the detailed description above is merely by way of example and does not constitute a limitation on the present disclosure. Although not explicitly stated herein, a person skilled in the art may make various modifications, improvements, and corrections to the present disclosure. Such modifications, improvements, and corrections are suggested in the present disclosure. Therefore, such modifications, improvements, and corrections still fall within the spirit and scope of the exemplary embodiments of the present disclosure.

Meanwhile, the present disclosure uses specific words to describe embodiments of the present disclosure. For example, “an embodiment,” “one embodiment,” and/or “some embodiments” mean a certain feature, structure, or characteristic related to at least one embodiment of the present disclosure. Therefore, it should be emphasized and noted that “an embodiment” or “one embodiment” or “an alternative embodiment” mentioned two or more times in different places in the present disclosure does not necessarily refer to the same embodiment. In addition, certain features, structures, or characteristics in one or more embodiments of the present disclosure may be appropriately combined.

In addition, the order of processing elements and sequences described in the present disclosure, the use of numbers and letters, or the use of other names are not used to limit the order of processes and manners of the present disclosure. Although the foregoing disclosure discusses some inventive embodiments currently considered useful through various examples, it should be understood that such details are for illustrative purposes only. For example, although the implementation of various components described above may be embodied in a hardware device, it may also be implemented as a software only solution, e.g., an installation on an existing server or mobile device.

Similarly, it should be noted that, in order to simplify the expression disclosed in the present disclosure and thereby help understand one or more inventive embodiments, in the foregoing description of the embodiments of the present disclosure, various features are sometimes grouped into one embodiment, one drawing, or a description thereof. Rather, claimed subject matter may lie in less than all features of a single foregoing disclosed embodiment.

In some embodiments, numbers describing quantities of components or attributes are used. It should be understood that such numbers used to describe the embodiments are modified by the modifiers “about,” “approximately,” or “substantially” in some examples. Unless otherwise stated, “about,” “approximately,” or “substantially” indicates that the stated number allows a variation of ±20%. Accordingly, in some embodiments, numerical parameters used in the specification are approximate values, and the approximate values may change according to characteristics required by individual embodiments. In some embodiments, numerical parameters should consider specified significant digits and adopt a general manner of digit retention. Although numerical ranges and parameters used to confirm the breadth of the scope in some embodiments of the present disclosure are approximate values, in specific embodiments, setting of such numerical values is as precise as possible within a feasible range.

Each patent, patent present disclosure, patent present disclosure publication, and other material, such as articles, books, specifications, publications, documents, etc., cited in the present disclosure is hereby incorporated into the present disclosure in its entirety by reference. Excluded are present disclosure history documents that are inconsistent with or conflict with the content of the present disclosure, and also excluded are documents that limit the broadest scope of the present disclosure (whether currently or later attached to the present disclosure). It should be noted that, if descriptions, definitions, and/or use of terms in the attached materials of the present disclosure are inconsistent with or conflict with the content described in the present disclosure, the descriptions, definitions, and/or use of terms in the present disclosure shall prevail.

Finally, it should be understood that the embodiments described in the present disclosure are only used to illustrate principles of the embodiments of the present disclosure. Other variations may also fall within the scope of the present disclosure. Therefore, by way of example and not limitation, alternative configurations of the embodiments of the present disclosure may be considered consistent with the teachings of the present disclosure. Accordingly, the embodiments of the present disclosure are not limited to the embodiments explicitly introduced and described in the present disclosure.

What is claimed is:

1. A fabrication mold for an ultra-high performance concrete-normal concrete (UHPC-NC) specimen, comprising a base, an assembled cylindrical barrel, a top cover, and an interface partition plate, wherein a middle portion of the base is provided with a circular boss, the assembled cylindrical barrel is arranged at an outer periphery of the circular boss, the interface partition plate is vertically inserted into a middle portion of the assembled cylindrical barrel, and the top cover is buckled on a top portion of the assembled cylindrical barrel;
the assembled cylindrical barrel is formed by splicing a plurality of arc plates, an outer wall of each of the plurality of arc plates is provided with a detachable assembly, the detachable assembly includes a positioning plate, a limit shaft, and a regulator, the positioning plate is fixedly connected to the base; the limit shaft and the regulator are respectively connected to each of the plurality of arc plates and penetrate through the positioning plate, and an opening-closing state of the assembled cylindrical barrel is adjusted by rotating the regulator, and
the interface partition plate includes a base master plate, an adjustable sub plate, and a pushing element, the base master plate is connected to the circular boss, and two ends of the base master plate abut against an inner wall of the assembled cylindrical barrel, the adjustable sub plate and the pushing element are cooperatively mounted on the base master plate, one side of the base master plate is configured to form a predetermined specimen interface morphology, and one side of the adjustable sub plate is configured to form a variable specimen interface morphology.

2. The fabrication mold according to claim 1, wherein the regulator includes a rotating handle, a threaded rod, and a connecting disc, the threaded rod is movably mounted through the positioning plate, the rotating handle and the connecting disc are respectively connected to two ends of the threaded rod, and the connecting disc is located inside a first mounting disc on the outer wall of an arc plate.

3. The fabrication mold according to claim 2, wherein one side of the base master plate is provided with a plurality of rectangular protrusions, and another side of the base master plate is uniformly provided with a plurality of limiting posts, a gap is formed between the plurality of rectangular protrusions and the plurality of limiting posts, each of the plurality of limiting posts includes two L-shaped baffles symmetrical to each other, and a spacing is provided between the two L-shaped baffles.

4. The fabrication mold according to claim 3, wherein the adjustable sub plate includes a plurality of T-shaped posts and an elastic arc panel, the plurality of T-shaped posts are distributed on one side of the elastic arc panel, each of the plurality of T-shaped posts is clamped in the spacing between the two L-shaped baffles, the elastic arc panel is located at an outer side of the base master plate, and the pushing element is inserted into the gap and passes through a gap between adjacent limiting posts to abut against the elastic arc panel.

5. The fabrication mold according to claim 4, further comprising an interface adjustment member, wherein when an interface morphology of the adjustable sub plate needs to be changed, the interface adjustment member is movably inserted into the base master plate, the interface adjustment member pushes the pushing element to move toward a direction of the elastic arc panel, and the elastic arc panel is pushed to deform from an arc shape into a sawtooth shape.

6. A fabrication method for a UHPC-NC specimen by using the fabrication mold for the UHPC-NC specimen according to claim 5, and the fabrication method comprising:
combining the plurality of arc plates to form the assembled cylindrical barrel, and installing the interface partition plate in the assembled cylindrical barrel;
adding normal concrete (NC) to one side of the interface partition plate according to a requirement of a designed interface morphology of the UHPC-NC specimen, after curing is completed, removing the interface partition plate, then adding ultra-high performance concrete (UHPC) to fill the assembled cylindrical barrel, and continuing curing;
in response to fabricating a UHPC-NC specimen with a sawtooth-shaped interface, using the interface adjustment member to push the pushing element to deform the elastic arc panel from the arc shape into the sawtooth shape, then adding the NC to one side of the elastic arc panel, after curing is completed, removing the interface partition plate, then adding the UHPC to fill the assembled cylindrical barrel, and continuing curing, and
after curing is completed, rotating a plurality of rotating handles to drive the plurality of arc plates to move away from each other by using threaded rods, thereby opening the assembled cylindrical barrel, and taking out the UHPC-NC specimen.

7. The fabrication method according to claim 6, further comprising:
during a process of adding the NC, obtaining a displacement magnitude and/or a lateral force of the pushing element by using at least one of a displacement sensor or a pressure sensor provided on the pushing element, and controlling the pushing element to perform a compensation adjustment based on the displacement magnitude and/or the lateral force.
